(19) United States
(12) Patent Application Publication
(10) Pub. No.: US 2015/0163157 A1
(43) Pub. Date: Jun. 11, 2015

(54) ALLOCATION AND MIGRATION OF CLOUD RESOURCES IN A DISTRIBUTED CLOUD SYSTEM

(71) Applicant: Alcatel-Lucent USA Inc., Murray Hill, NJ (US)

(72) Inventors: Fang Hao, Morganville, NJ (US); Murali Kodialam, Marlboro, NJ (US); Tirunell V. Lakshman, Morganville, NJ (US); Sarit Mukherjee, Morganville, NJ (US)

(73) Assignee: Alcatel-Lucent USA Inc., Murray Hill, NJ (US)

(21) Appl. No.: 14/100,081

(22) Filed: Dec. 9, 2013

(51) Int. Cl. H04L 12/911

(52) U.S. Cl. CPC H04L 47/70

(57) ABSTRACT

A capability is provided for allocating and migrating cloud resources in a distributed cloud system. A cloud resource request is received and an associated cloud resource allocation is determined. The cloud resource request includes cloud resource request information. The cloud resource request information includes a cloud resource allocation parameter associated with allocation of requested cloud resources responsive to the cloud resource request and a cloud resource migration parameter associated with migration of cloud resources allocated responsive to the cloud resource request. The cloud resource allocation includes cloud resource allocation information specifying allocation of cloud resources within the cloud system responsive to the cloud resource request and cloud resource migration information specifying migration of cloud resources allocated within the cloud system responsive to the cloud resource request.

### TECHNICAL FIELD

The disclosure relates generally to communication networks and, more specifically but not exclusively, to allocation of resources in a distributed cloud system.

### BACKGROUND

Many cloud operators currently host cloud services using centralized cloud systems as opposed to distributed cloud systems, although some cloud operators are beginning to provide cloud services using distributed cloud systems. In general, a centralized cloud system typically includes less data centers than a distributed cloud system, and the data centers of a centralized cloud system are typically larger than the data centers of a distributed cloud system. The use of a distributed cloud system, as opposed to a centralized cloud system, may be economically feasible for some service providers, such as for service providers that already have existing facilities distributed across wide areas (e.g., Central Offices of network providers that already have a large base of existing infrastructure).

In such centralized cloud systems, a requester may request the use of one or more resources from a cloud operator and the cloud operator may then allocate the requested resources from one of the data centers for use by the requestor. The use of a centralized cloud system, however, while suitable for exploiting the economic benefit of large scales, tends to introduce limitations such as increased latency experienced by users and potential reliability issues. While the use of a distributed cloud system, as opposed to a centralized cloud system, may reduce the latency experienced by users, allocation of resources to a requester in a distributed cloud system generally is more complicated than allocation of resources to a requester in a centralized cloud system.

### SUMMARY OF EMBODIMENTS

Various deficiencies in the prior art are addressed by embodiments for allocating virtual resources in a cloud system while also supporting migration of allocated virtual resources in the cloud system.

In at least some embodiments, an apparatus is configured for allocating cloud resources within a cloud system. The apparatus includes a processor and a memory communicatively connected to the processor. The processor is configured to receive a cloud resource request including cloud resource request information. The cloud resource request information includes a cloud resource allocation parameter associated with allocation of requested cloud resources responsive to the cloud resource request. The cloud resource request information includes a cloud resource migration parameter associated with migration of cloud resources allocated responsive to the cloud resource request. The processor is configured to determine a cloud resource allocation based on the cloud resource allocation parameter and the cloud resource migration parameter. The cloud resource allocation includes cloud resource allocation information specifying allocation of cloud resources within the cloud system responsive to the cloud resource request. The cloud resource allocation includes cloud resource migration information specifying migration of cloud resources allocated within the cloud system responsive to the cloud resource request.

In at least some embodiments, a method is configured for allocating cloud resources within a cloud system. The method includes using a processor and a memory for receiving a cloud resource allocation request and determining a cloud resource allocation. The cloud resource request includes cloud resource request information. The cloud resource request information includes a cloud resource allocation parameter associated with allocation of requested cloud resources responsive to the cloud resource request. The cloud resource request information includes a cloud resource migration parameter associated with migration of cloud resources allocated responsive to the cloud resource request. The cloud resource allocation is determined based on the cloud resource allocation parameter and the cloud resource migration parameter. The cloud resource allocation includes cloud resource allocation information specifying allocation of cloud resources within the cloud system responsive to the cloud resource request. The cloud resource allocation includes cloud resource migration information specifying migration of cloud resources allocated within the cloud system responsive to the cloud resource request.

In at least some embodiments, a computer-readable storage medium stores instructions which, when executed by a computer, cause the computer to perform a method for allocating cloud resources within a cloud system. The method includes receiving a cloud resource allocation request and determining a cloud resource allocation. The cloud resource request includes cloud resource request information. The cloud resource request information includes a cloud resource allocation parameter associated with allocation of requested cloud resources responsive to the cloud resource request. The cloud resource request information includes a cloud resource migration parameter associated with migration of cloud resources allocated responsive to the cloud resource request. The cloud resource allocation is determined based on the cloud resource allocation parameter and the cloud resource migration parameter. The cloud resource allocation includes cloud resource allocation information specifying allocation of cloud resources within the cloud system responsive to the cloud resource request. The cloud resource allocation includes cloud resource migration information specifying migration of cloud resources allocated within the cloud system responsive to the cloud resource request.

### BRIEF DESCRIPTION OF THE DRAWINGS

The teachings herein can be readily understood by considering the following detailed description in conjunction with the accompanying drawings, in which:

FIG. 1 depicts an exemplary distributed cloud system being managed by a cloud resource management system;

FIG. 2 depicts an embodiment of a method for determining allocation of cloud resources in a distributed cloud system;

FIG. 3 depicts an embodiment of a method for determining allocation of cloud resources in a distributed cloud system; and

FIG. 4 depicts a high-level block diagram of a computer suitable for use in performing functions described herein.

To facilitate understanding, identical reference numerals have been used, where possible, to designate identical elements common to the figures.

### DETAILED DESCRIPTION OF EMBODIMENTS

In general, a cloud resource management capability is provided for performing allocation and migration of cloud resources in a cloud system. In at least some embodiments, allocation of cloud resources within a distributed cloud system may include receiving a request for allocation of cloud resources within the cloud system where the request for allocation of cloud resources includes cloud resource allocation parameters associated with allocation of the cloud resources being requested and also includes cloud resource migration parameters associated with migration of cloud resources to be allocated in response to the request for allocation of cloud resources, determining a cloud resource allocation based on the request for allocation of cloud resources where the cloud resource allocation specifies a mapping of the requested cloud resources onto physical resources of the cloud system and also specifies cloud resource migration information for controlling migration of the cloud resources allocated in response to the request for allocation of cloud resources. The specification of cloud resource migration information as part of the cloud resource allocation determined in response to a request for cloud resources enables use of the cloud resource migration information to provide a more intelligent allocation of cloud resources that accounts for one or more future migrations of the cloud resources being allocated. The specification of cloud resource migration information as part of the cloud resource allocation determined in response to a current request for cloud resources also enables use of the cloud resource migration information of the cloud resource allocation to be used to determine future cloud resource allocations in response to future requests for cloud resources of the distributed cloud system. It will be appreciated that, although primarily depicted and described with respect to use of the cloud resource allocation capability within the context of a specific type of system (namely, a distributed cloud system) to manage specific types of resources (namely, cloud resources), the cloud resource allocation capability also may be used within the context of any suitable types of systems in which any suitable types of resources may be allocated and migrated.

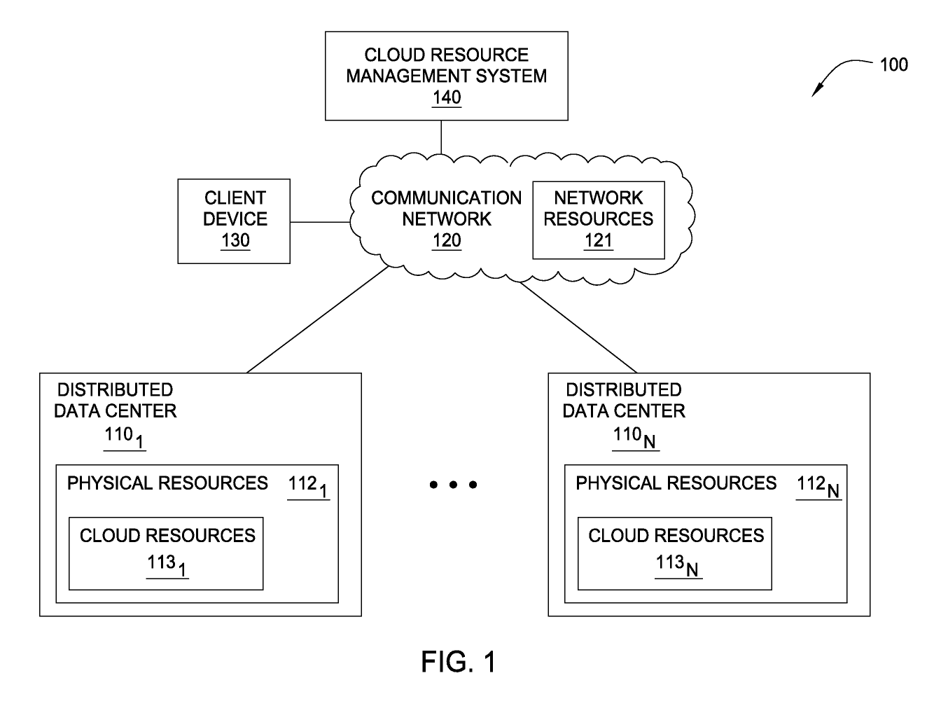

FIG. 1 depicts an exemplary distributed cloud system being managed by a cloud resource management system.

The distributed cloud system (DCS) 100 includes a plurality of distributed data centers (DDCs) 110₁-110_{N} (collectively, DDCs 110), a communication network (CN) 120, a client device (CD) 130, and a cloud resource management system (CRMS) 140.

The DDCs 110 may be configured to support cloud services for cloud consumers. For example, cloud services may include cloud computing services, Infrastructure as a Service (IaaS), or the like. The DDCs 110 may include various types and configurations of resources which may be used to support cloud services for cloud consumers. The resources may include various types and configurations of physical resources which may be used to support various types and configurations of virtual resources. The DDCs 110₁-110_{D} may communicate with CN 120 via communication paths 109₁-109_{D} (collectively, communication paths 109), respectively.

The DDCs 110 include respective sets of physical resources (PRs) 112₁-112_{D} (collectively, PRs 112) which may be used to provide cloud services for cloud consumers. For example, PRs 112 of a DDC 110 may include computing resources, memory resources, storage resources, networking resources, or the like. For example, PRs 112 of a DDC 110 may include servers, processor cores, memory devices, storage devices, networking devices (e.g., switches, routers, or the like), communication links, or the like. More specifically, for example, PRs 112 of a DDC 110 may include host servers configured to host virtual resources within the DDC 110 (e.g., including server blades organized in racks and connected via respective top-of-rack (TOR) switches, hypervisors, or the like), aggregating switches and routers configured to support communications of host servers within the DDC 110 (e.g., between host servers within the DDC 110, between host servers of the DDC 110 and devices located outside of the DDC 110, or the like), or the like, as well as various combinations thereof. The typical configuration and operation of PRs of a datacenter (e.g., such as PRs 112 of one or more of the DDCs 110) will be understood by one skilled in the art.

The PRs 112 of the DDCs 110 are configured to support respective sets of cloud resources (CRs) 113₁-113_{D} (collectively, CRs 113) for cloud consumers. For example, CRs 113 supported using PRs 112 of a DDC 110 may include virtual computing resources, virtual memory resources, virtual storage resources, virtual networking resources (e.g., bandwidth), or the like, as well as various combinations thereof (e.g., virtual machines (VMs), virtual applications, virtual application instances, virtual file systems, or the like). The allocation of CRs 113 of DDCs 110 may be requested by cloud consumers via cloud resource allocation requests to CRMS 140. It will be appreciated that the typical configuration and operation of VRs using PRs of a datacenter (e.g., such as CRs 113 using PRs 112 of one or more of the DDCs 110) will be understood by one skilled in the art.

The DDCs 110 (or at least a portion of the DDCs 110) may be distributed geographically. The DDCs 110 may be located at any suitable geographic locations. The DDCs 110 may be distributed across a geographic area of any suitable size (e.g., globally, on a particular continent, within a particular country, within a particular portion of a country, or the like). The DDCs 110 may be located relatively close to the end users. For example, where the cloud provider may be a network service provider, at least a portion of the DDCs 110 may be implemented within Central Offices (COs) of the network service provider. It will be understood that, as traditional telecommunications equipment deployed in the COs has become more compact, real estate has become available at the COs and may be used for deployment of servers configured to operate as part of a distributed cloud system. It also will be understood that such COs generally tend to be highly networked, such that they may be configured to support the additional traffic associated with a distributed cloud system.

The CN 120 may include any communication network(s) suitable for supporting communications within DCS 100 (e.g., between DDCs 110, between CD 130 and DDCs 110, between CD 130 and CRMS 140, between CRMS 140 and DDCs 110, or the like). For example, CN 120 may include one or more wireline networks or one or more wireless networks, which may include one or more of a Global System for Mobile (GSM) based network, a Code Divisional Multiple Access (CDMA) based network, a Long Term Evolution (LTE) based network, a Local Area Network (LAN), a Wireless Local Area Network(s) (WLAN), a Metropolitan Area Network (MAN), a Wide Area Network (WAN), or the like. The CN 120 includes network resources 121 that are configured to support communications within DCS 100, including support for communications associated with access and use of CRs 113 of DDCs 110 (e.g., between DDCs 110, between CD 130 and DDCs 110, or the like). For example, network resources 121 may include network elements (e.g., data routing devices, control functions, or the like), communication links, or the like, as well as various combinations thereof. In at least some cases (e.g., where DDCs 110 are provided by a network service provider that also provides CN 120), allocation of network resources 121 (e.g., bandwidth or other suitable types of network resources 121) may be requested by cloud consumers in conjunction with cloud resource allocation requests to CRMS 140.

The CD 130 is a client device configured to function within DCS 100. For example, CD 130 may be configured to communicate with CRMS 140 for purposes of requesting allocation of cloud resources within DDCs 110. For example, CD 130 may be configured to communicate with DDCs 110 for purposes of accessing and using virtual resources allocated for CD 130 within DDCs 110 (e.g., allocated responsive to a resource allocation request from CD 130 or any other device(s)). For example, CD 130 may be a thin client, a smartphone, a tablet computer, a laptop computer, a desktop computer, a television set-top-box, a media player, a gateway, a server, a network device, or the like.

The CRMS 140 may be configured to support management of resources within DCS 100. The CRMS 140 may be configured to support management of virtual resources (e.g., CRs 113 of DDCs 110 and, optionally, network resources 121 of CN 120), including allocation of available virtual resources (e.g., available CRs 113 of DDCs 110 and, optionally, available network resources 121 of CN 120), migration of allocated virtual resources (e.g., migration of allocated CRs 113 of DDCs 110 (e.g., between servers within DDCs 110, between DDCs 110, or the like) and, optionally, migration of allocated network resources 121 of CN 120), or the like, as well as various combinations thereof. The CRMS 140 may be configured to control allocation and migration of CRs 113 within DCS 100. The CRMS 140 may be configured to allocate CRs 113 within DCS 100 based on expected future migration of the CRs 113 being allocated within DCS 100. The CRMS 140 may be configured to allocate CRs 113 within DCS 100 in a manner enabling specification of and control over migration of the CRs 113s within DCS 100 following allocation of the CRs 113 within DCS 100.

The CRMS 140 may be configured to receive a cloud resource allocation request and determine a cloud resource allocation in response to the cloud resource allocation request. The cloud resource allocation request may be received from any suitable device of the cloud consumer requesting CRs 113 (e.g., from CD 130 or from a device that is obtaining an allocation of CRs 113 for use by CD 130). The cloud resource allocation request may include cloud resource allocation parameters specifying the allocation of CRs 113 being requested (e.g., the type or types of CRs 113 requested, the quantity or quantities of CRs 113 requested, and, optionally, one or more cloud consumer allocation rules according to which the CRs 113 are to be allocated (e.g., the location(s) of the CRs 113 requested, one or more allocation rules according to which the CRs 113 are to be allocated, network latency bounds, or the like)). The cloud resource allocation request also may include one or more cloud resource migration parameters associated with migration of CRs 113 to be allocated in response to the cloud resource allocation request (e.g., a time at which an allocated CR 113 is to be migrated, a location from which an allocated CR 113 is to be migrated, a location to which an allocated CR 113 is to be migrated, one or more of the cloud resource allocation parameters according to which an allocated CR 113 is to be migrated, or the like, as well as various combinations thereof).

The CRMS 140 may be configured to determine the cloud resource allocation based on the cloud resource allocation request (e.g., based on cloud resource allocation parameters, cloud resource migration parameters, or the like, as well as various combinations thereof). The CRMS 140 may be configured to determine the cloud resource allocation based on one or more of characteristics of available CRs 113, characteristics of DDCs 110 hosting available CRs 113 (e.g., loading of the DDC 110, characteristics of network connectivity within DDCs 110, or the like), characteristics of CN 120 (e.g., characteristics of network connectivity between DDCs 110, network status information associated with CN 120, or the like), one or more objectives of the cloud provider (e.g., balancing the load, maximizing the revenue, or the like), or the like. The cloud resource allocation may specify a mapping of the allocated CRs 113 onto PRs 112 of DDCs 110. The cloud resource allocation also may specify cloud resource migration information that is indicative of planned migration of the allocated CRs 113 between PRs 112 of DDCs 110 and, thus, is adapted for use in controlling migration of the allocated CRs 113 between PRs 112 of DDCs 110. In at least some embodiments, the cloud resource migration information of a cloud resource allocation also may be referred to as a cloud resource migration plan.

The CRMS 140 may be configured to control allocation of CRs 113 based on the cloud resource allocation that is determined by CRMS 140. The CRMS 140 may be configured to communicate with one or more of the DDCs 110 for controlling provisioning of CRs 113 of DDCs 110 based on the cloud resource allocation that is determined by CRMS 140.

The CRMS 140 may be configured to provide a cloud resource allocation response, to a device from which the associated cloud resource allocation request was received (e.g., CD 130, a device that is obtaining an allocation of CRs 113 for use by CD 130, or the like), responsive to the cloud resource allocation request. The cloud resource allocation response may include one or more of an indication as to whether the cloud resource allocation request has been satisfied by CRMS 140, information indicative of the cloud resource allocation determined by CRMS 140 (e.g., locations of CRs 113 allocated, addresses for use in communicating with CRs 113 allocated, cloud resource migration information, and so forth) or the like, as well as various combinations thereof.

The CRMS 140 may be configured to control migration of cloud resources within DCS 100. The CRMS 140 may be configured to control migration of allocated CRs 113 based on cloud resource migration information specified as part of the cloud resource allocation which specifies allocation of the allocated CRs 113 in response to the cloud resource allocation request. The CRMS 140 may be configured to control migration of allocated CRs 113 based on other suitable information (e.g., cloud resource allocation parameters specified as part of the cloud resource allocation request which resulted in allocation of the allocated CRs 113, status information associated with the DDCs 110 (e.g., the current load at the DDCs 110, the expected load at the DDCs 110, or the like), or the like, as well as various combinations thereof). The CRMS 140 may be configured to control migration of allocated CRs 113 between PRs 112. The CRMS 140 may be configured to control migration of a set of allocated CRs 113 from a first set of PRs 112 to a second set of PRs 112. For example, CRMS 140 may be configured to control migration of a VM from a first host server to a second host server within a DDC 110, from a host server of a first DDC 110 to a host server of a second DDC 110, or the like. Similarly, for example, CRMS 140 may be configured to control migration of a set of VMs from host servers on a first rack to host servers on a second rack within a DDC 110, from host servers within a first DDC 110 to host servers within a second DDC 110, or the like. The CRMS 140 may be configured to support various other types of resource migrations for migration of allocated CRs 113 allocated in response to the cloud resource allocation request.

It is noted that specification of cloud resource migration information as part of the cloud resource allocation determined in response to a request for cloud resources enables use of the cloud resource migration information to provide a more intelligent allocation of cloud resources that accounts for one or more future migrations of the cloud resources being allocated.

It is noted that specification of cloud resource migration information as part of the cloud resource allocation determined in response to the current cloud resource allocation request enables use of the cloud resource migration information of the cloud resource allocation to be used to determine future cloud resource allocations in response to future cloud resource allocation requests received by CRMS 140. The CRMS 140 may be configured to allocate cloud resources within DCS 100 responsive to a current cloud resource allocation request in a manner tending to increase or maximize the acceptance of one or more future cloud resource allocation requests for allocation of cloud resources within DCS 100. It will be appreciated that, since future cloud resource requests generally are not known a priori, allocation of available CRs 113 in response to a current cloud resource request may be performed online in the sense that allocation of available CRs 113 in response to the current cloud resource request may be made without knowledge of any cloud resource requests that arrive in the future. The CRMS 140 may be configured to allocate CRs 113 responsive one or more future cloud resource allocation requests based on cloud resource migration information specified for one or more cloud resource allocations determined and implemented by CRMS 140 responsive to one or more past cloud resource allocation requests. This may ensure or tend to ensure that the load on the DDCs 110 distributed and uniform. The CRMS 140 may be configured to receive a cloud resource allocation request and determine an allocation of cloud resources within DCS 100 based on cloud resource allocation parameters associated with the cloud resource allocation request and cloud resource allocations within DCS 100 (e.g., cloud resource allocation information including cloud resource migration information specified as part of the cloud resource allocation), The CRMS 140 may be configured to improve allocation of cloud resources within DCS 100 based on cloud resource migration information associated with DCS 100 in various other ways.

The CRMS 140 may be configured to perform various other functions of the cloud resource allocation capability.

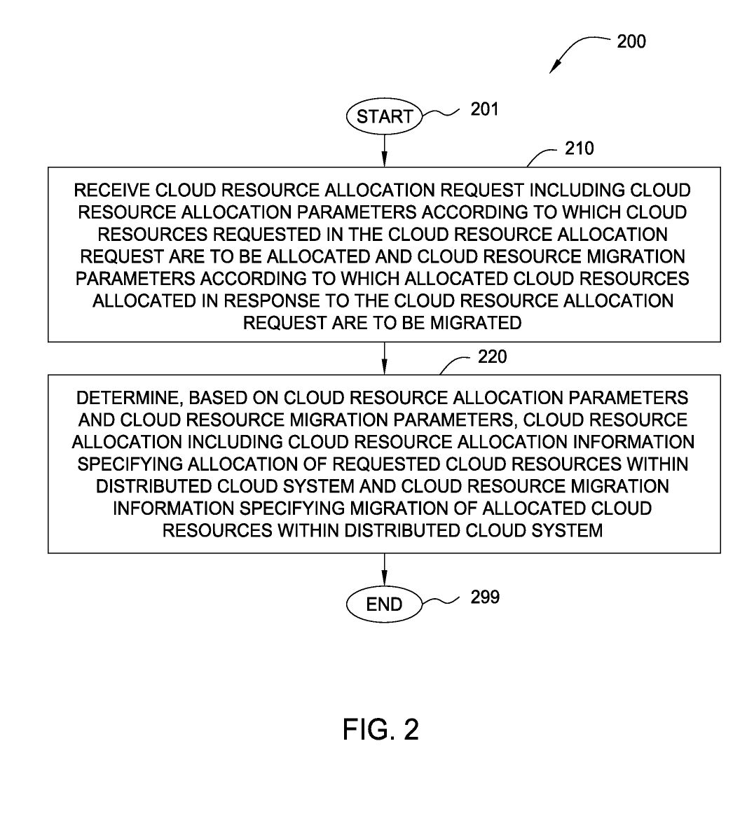

FIG. 2 depicts an embodiment of a method for determining allocation of cloud resources in a distributed cloud system. It will be appreciated that, although primarily depicted and described as being performed serially, at least a portion of the steps of method 200 may be performed contemporaneously or in a different order than depicted in FIG. 2.

At step 201, method 200 begins.

At step 210, a cloud resource allocation request is received. The cloud resource allocation request includes cloud resource request information. The cloud resource request information may include cloud resource allocation parameters associated with allocation of the cloud resources being requested, cloud resource migration parameters associated with migration of cloud resources to be allocated in response to the cloud resource allocation request, or the like, as well as various combinations thereof.

The cloud resource request information may include cloud resource allocation parameters associated with allocation of the cloud resources being requested. The cloud resource allocation parameters may include any information which may be used to determine the allocation of the cloud resources requested in the cloud resource allocation request. The cloud resource allocation parameters may include parameters according to which cloud resources requested in the cloud resource allocation request are to be allocated. For example, the cloud resource allocation parameters may include indications of the type or types of cloud resources requested, the quantity or quantities of cloud resources requested, the duration or durations of time for which use of the cloud resources is requested, one or more cloud consumer allocation rules according to which the cloud resource are or may be allocated (e.g., location(s) at which the cloud resources are to be allocated (e.g., one or more geographic locations, one or more data centers, one or more locations within one or more data centers, or the like), one or more anti-affinity rules according to which the cloud resources are to be allocated, one or more latency constraints associated with communications using the cloud resources to be allocated, or the like), or the like, as well as various combinations thereof.

The cloud resource request information may include cloud resource migration parameters associated with migration of cloud resources to be allocated in response to the cloud resource allocation request. The cloud resource migration parameters may include any information which may be used to determine and control migration of cloud resources allocated in response to the cloud resource allocation request. The cloud resource migration parameters may include parameters according to which allocated cloud resources allocated in response to the cloud resource allocation request are to be migrated. For example, the cloud resource migration parameters may include a time or times at which cloud resources are to be migrated, a location or locations from/to which cloud resources are to be migrated, a maximum number of times cloud resources may be migrated, or the like, as well as various combinations thereof. The cloud resource migration parameters also may be considered to include any of the cloud resource allocation parameters which may be used in order to determine and control migration of cloud resources allocated in response to the cloud resource allocation request.

It will be appreciated that any of the cloud resource request information may be considered to be a constraint or constraints as such information may constrain the allocation of cloud resources in response to the cloud resource request, the migration of cloud resources allocated in response to the cloud resource allocation request, or the like.

It also will be appreciated that, although primarily depicted and described with respect to embodiments in which the cloud resource request information is included within the cloud resource allocation request, some or all of the cloud resource request information may be provided or otherwise obtained outside of the cloud resource allocation request.

At step 220, a cloud resource allocation is determined for the cloud resource allocation request. The cloud resource allocation may be determined based on the cloud resource allocation parameters and the cloud resource migration parameters. The cloud resource allocation may include cloud resource allocation information, cloud resource migration information, or the like.

The cloud resource allocation may include cloud resource allocation information. The cloud resource allocation information is determined based on the cloud resource allocation parameters and also may be determined based on cloud resource migration parameters. The cloud resource allocation information specifies a mapping of the requested cloud resources to physical resources of the distributed cloud system. For example, the cloud resource allocation information may include identification, for each cloud resource, a location at which the cloud resource is to be hosted (e.g., data center, rack, server, or the like).

The cloud resource allocation may include cloud resource migration information. The cloud resource migration information is determined based on the cloud resource migration parameters and also may be determined based on cloud resource allocation parameters. The cloud resource migration information specifies migration of allocated cloud resources within the distributed cloud system. For example, cloud resource migration information may include at least one of a time or times at which cloud resources are to be migrated, a location or locations from/to which cloud resources are to be migrated (e.g., from a first set of physical resources of the distributed cloud system to a second set of physical resources of the distributed cloud system), or the like.

At step 299, method 200 ends.

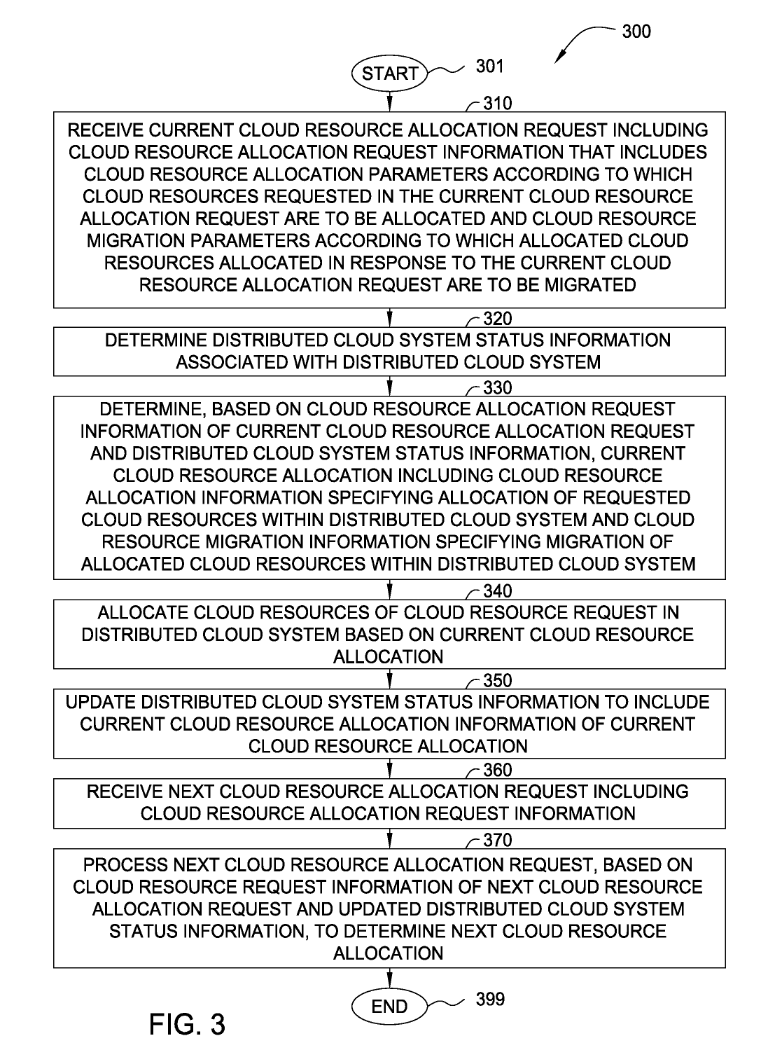

It will be appreciated, at least from method 200 of FIG. 2, that cloud resource migration information associated with a current cloud resource allocation request may be determined based on cloud resource migration parameters associated with the current cloud resource allocation request. Additionally, as discussed herein, the cloud resource migration information associated with a current cloud resource allocation request may be determined based on cloud resource migration information determined for any previous cloud resource allocation requests. This may be handled via one or more of a direct use of cloud resource migration information of previous cloud resource allocations determined for previous cloud resource allocation requests to handle the current cloud resource allocation request, updating of distributed cloud system status information to include cloud resource migration information of previous cloud resource allocations and use of the updated distributed cloud system status information to handle the current cloud resource allocation request (an exemplary embodiment of which is depicted in FIG. 3), or the like, as well as various combinations thereof.

FIG. 3 depicts an embodiment of a method for determining allocation of cloud resources in a distributed cloud system. It will be appreciated that, although primarily depicted and described as being performed serially, at least a portion of the steps of method 300 may be performed contemporaneously or in a different order than depicted in FIG. 3.

At step 301, method 300 begins.

At step 310, a current cloud resource allocation request is received. The current cloud resource allocation request includes cloud resource request information. The cloud resource request information may include cloud resource allocation parameters associated with allocation of the cloud resources being requested, cloud resource migration parameters associated with migration of cloud resources to be allocated in response to the cloud resource allocation request, or the like, as well as various combinations thereof.

At step 320, distributed cloud system status information associated with the distributed cloud system is determined. The distributed cloud system status information may include one or more of indications of cloud resources available at the datacenters of the distributed cloud system, indications of cloud resources already allocated at the datacenters of the distributed cloud system (e.g., which may be indicative of load on the data centers), indications of available network resources of communication networks that are available to support communications between ones of the distributed data centers, or the like, as well as various combinations thereof. The distributed cloud system status information may include cloud resource allocation of cloud resource allocations made in response to previous cloud resource allocation requests (as such cloud resource allocation requests have already been processed such that the cloud resource allocations performed in response to the previous cloud resource allocation requests need to be accounted for), which may include cloud resource migration information specifying cloud resource migrations of cloud resources allocated in response to previous cloud resource allocation requests.

At step 330, a current cloud resource allocation is determined for the current cloud resource allocation request. The current cloud resource allocation may be determined based on the cloud resource allocation request information of the current cloud resource allocation request (e.g., the cloud resource allocation parameters and the cloud resource migration parameters). The current cloud resource allocation may include cloud resource allocation information, cloud resource migration information, or the like.

At step 340, cloud resources of the current cloud resource request are allocated in the distributed cloud system based on the current cloud resource allocation.

At step 350, the distributed cloud system status information is updated to include the current cloud resource allocation information of the current cloud resource allocation. In this manner, the cloud resource migration information, in addition to the cloud resource allocation information, of the current cloud resource allocation is made available for use in processing future cloud resource allocation requests.

At step 360, a next cloud resource allocation request is received. The next cloud resource allocation request includes cloud resource request information. The cloud resource request information may include cloud resource allocation parameters associated with allocation of the cloud resources being requested, cloud resource migration parameters associated with migration of cloud resources to be allocated in response to the cloud resource allocation request, or the like, as well as various combinations thereof.

At step 370, the next cloud resource allocation request is processed based on the loud resource request information of the next cloud resource allocation request and the updated distributed cloud system status information. As noted above, since the updated distributed cloud system status information include the cloud resource migration information associated with the previously current (now previous) cloud resource allocation, the allocation of cloud resources responsive to the next cloud resource allocation request may be determined while taking into account planned migrations of previously allocated cloud resources.

At step 399, method 300 ends.

In at least some embodiments, the problem of allocating available cloud resources of a cloud system (e.g., CRs 113 of DDCs 110 of DCS 100) for a current cloud resource request in a manner tending to increase or maximize the acceptance of one or more future cloud resource allocation requests may be formulated as a primal-dual process where information used for allocation of cloud resources in response to a cloud resource allocation request (e.g., information included in the cloud resource allocation request, distributed cloud system status information, one or more cloud resource migration plans, or the like) is modeled as a set of constraints and the objective is to maximize the revenue of the cloud provider. A description of an exemplary embodiment of the problem formulation and the associated cloud resource allocation process (which uses VM allocation as a non-limiting example, since cloud resources may include other types of cloud processing, cloud memory resources, cloud storage resources, or the like) follows.

Referring again to FIG. 1, in at least some embodiments the CRMS 140 may be configured to represent the system as a time slotted system in which time slots are indexed by t and the time slotted system includes n cloud locations (e.g., DDCs 110), which also may be referred to more generally herein as cloud resource locations or locations. In the time slotted system, the time slots indexed by t may use any suitable increments of time (e.g., seconds, minutes, hours, days, or the like). In the time slotted system, the cloud locations are indexed by i and each cloud location i has capacity to host B(i,t) VMs in time slot t. The values of B(i,t) may be assumed to be known to CRMS 140. It will be appreciated that, although primarily presented within the context of embodiments in which the cloud resources (illustratively, CRs 113) being allocated are VMs, the cloud resources being allocated may include any types of cloud resources that may be supported by the system and that may be specified as part of a cloud resource allocation request (e.g., other types of cloud processing resources, cloud memory resources, cloud storage resources, or the like). In the time slotted system, the distance between two cloud locations (e.g., DDCs 110) i and i′ is defined as δ(i,t). The distance between two cloud locations i and i′ may be the physical distance, the length of the shortest path from cloud location i to cloud location i′ in the underlying network, the estimated mean delay to transfer a packet from cloud location i to cloud location i′, or any other suitable measure of distance.

The CRMS 140 is configured to receive cloud resource allocation requests (which also may be referred to as arrivals to CRMS 140 or arrivals to the system). In the time slotted system, the cloud resource allocation requests are requests for VMs and, thus, also may be referred to as VM requests. The VM requests are indexed by l. The VM request l has the following information associated therewith:

(1) a group of VMs requested (denoted as m(l)), where the VMs belonging to a particular VM request are indexed by j;

(2) the number of VMs requested (denoted as N(l,j)) for VM group j for VM request l;

(3) a set of time slots T(l) during which the requested VMs of VM request l are to be instantiated; and

(4) a set of allocation constraints to be satisfied by the group of VMs requested (e.g., constraints on the cloud locations i at which the requested VMs may be instantiated, indications of cloud locations i at which the requested VMs cannot be instantiated, or the like, as well as various combinations thereof).

It is noted that, with respect to the set of time slots T(l), the set of time slots T(l) may or may not include a contiguous time interval. Let L(l)=|T(l)| represent the total number of time slots for request l. A more general VM request that can be accommodated is the case in which the number of VMs in VM group j of VM request l is a function of the time slot. In other words, the number of VMs can be given as N(l,j,t), which is defined for all t∈T(l). However, in order to keep the notation simple, embodiments of the VM allocation capability are primarily described within the context of the case in which the number of VMs of VM group j of VM request l is the same across all of the time slots in T(l) (namely, using N(l,j) rather than N(l,j,t)).

It is noted that VM migrations may be performed in order to prevent over-utilization of resources. In this problem formulation, assumptions are made that (1) the migration decisions for VM request l are determined when the VM request l is processed, (2) VMs of the VM request l can migrate at the beginning of any time slot to any set of cloud locations i satisfying the feasibility constraint, (3) migration of the VMs in the VM request l is based on the current state of the system (e.g., the current state of DDCs 110), (4) unplanned migration of VMs based on future utilization information is not permitted, and (5) migration of VMs is unconstrained in that there is no constraint on the number of times that the VMs of VM request l can be migrated during the lifetime of the VMs of VM request l. It will be appreciated that one of more of these assumptions may be relaxed or modified in various embodiments.

The set of allocation constraints may include one or more constraints on the cloud locations i (e.g., the DDCs 110) at which VMs of the VM request l can be instantiated. An example of one such allocation constraint is a cloud location restriction constraint defined as follows: VM j of VM request l is constrained to be located in the set of cloud locations S(l,j), where the set of cloud locations S(l,j) includes any cloud locations i that are within a distance of Δ from some given cloud location j, i.e., S(l,j)−{i′:δ(i, i′)≦Δ}.).

The distance may be measured in any suitable manner (e.g., as the physical distance, the length of the shortest path from cloud location i to cloud location i′ in the underlying network, the estimated mean delay to transfer a packet from cloud location i to cloud location i′, or any other suitable measure of distance).

The CRMS 140 may be configured to determine a VM allocation for the VM request l, where the VM allocation for the VM request l is a mapping of the requested VMs to cloud locations of the system (e.g., to DDCs 110 of the system). The VM allocation for the VM request l is determined such that (1) the set of allocation constraints specified as part of the VM request l are satisfied and (2) the capacity constraints at the cloud locations i are satisfied. The VM allocation for the VM request l may be represented as a resource mapping P of the VMs of VM request l to cloud locations land time slots t. Here, P(l,j,t) is used to denote the cloud location i of the N(l,j) VMs belonging to VM j of VM request l in time slot t∈T(l), and A(e,P,i,t) is used to denote the total number of VMs allocated to cloud location i at time slot t when resource mapping P is used to map the VM groups j for VM request l (namely,

$$A ( 𝓁 , P , i , t ) = {\sum }_{j : P ( 𝓁 , j , t ) = i}^{ } N ( 𝓁 , j ) ) .$$

Additionally, let Pₗ denote the set of resource mappings that are feasible for VM request l (where it is noted that the migration constraints are subsumed into the definition of Pₗ). In at least some embodiments, CRMS 140 is configured to support online allocation of VMs in response to VM requests without knowledge of future VM requests, and at least some such embodiments may be better understood by first considering offline allocation of VMs in response to VM requests in which the future VM demands are known in advance.

The CRMS 140 may support offline allocation of VMs in response to VM requests in which the future VM requests (which are indicative of the future VM demands) are known in advance. In at least some embodiments, the objective may be to determine a valid resource mapping P for each time slot t that maximizes the number of requested VMs that are actually allocated within the system (which also may be referred to herein as the number of accepted VMs). Let X_{P}^{l}(t)=1 if resource mapping P∈Pₗ is used for VM request l at time slot t, and let X_{P}^{l}(t)=0 otherwise. The problem of maximizing the number of accepted VMs can be written as:

$$\begin{matrix}max {\sum }_{𝓁}^{ } {\sum }_{t}^{ } {\sum }_{P ∈ {P}_{𝓁}}^{ } {\sum }_{i}^{ } A ( 𝓁 , P , i , t ) {X}_{P}^{𝓁} ( t ) \\ {\sum }_{P ∈ {P}_{𝓁}}^{ } {X}_{P}^{𝓁} ( t ) \leq 1 ∀ 𝓁 ∀ t & ( Eq . 1 ) \\ {\sum }_{𝓁 : T ( 𝓁 ) ∋ t}^{ } {\sum }_{P ∈ {P}_{𝓁}}^{ } A ( 𝓁 , P , i , t ) {X}_{P}^{𝓁} ( t ) \leq B ( i , t ) ∀ i ∀ t & ( Eq . 2 ) \\ {X}_{P}^{𝓁} ( t ) ∈ \{ 0 , 1 \} ∀ P , t . & ( Eq . 3 )\end{matrix}$$

Here, the bracketed term in the objective function is the total number of VMs instantiated at cloud location i if resource mapping P is chosen. Equation [1] ensures that, at most, one resource mapping is used in each time slot t. Equation [2] enforces the capacity constraint for each cloud location i in each time slot t. For purposes of clarity, consider a linear programming relaxation of the above problem in which 0≦X_{P}^{t}≦1. It is noted that the upper bound X_{P}^{t}≦1 is implied by Equation [1] and, thus, can be eliminated from the formulation. The dual to the above linear programming relaxation may be written as:

$$\begin{matrix}min {\sum }_{𝓁}^{ } π ( 𝓁 , t ) + {\sum }_{i}^{ } {\sum }_{t}^{ } B ( i , t ) δ ( i , t ) \\ π ( 𝓁 , t ) \geq {\sum }_{i}^{ } A ( 𝓁 , P , i , t ) [ 1 - δ ( i , t ) ] ∀ P ∈ {P}_{𝓁} ∀ t ∈ T ( 𝓁 ) & ( Eq . 4 ) \\ π ( 𝓁 , t ) \geq 0 ∀ 𝓁 & ( Eq . 5 ) \\ δ ( i , t ) \geq 0 ∀ i ∀ t . & ( Eq . 6 )\end{matrix}$$

Here, from Equation [4],

$$π ( 𝓁 , t ) = \begin{matrix}max \\ P ∈ {P}_{𝓁}\end{matrix} {\sum }_{i}^{ } A ( 𝓁 , P , i , t ) [ 1 - δ ( i , t ) ] .$$

It will be appreciated that, since information about the future will not be available at the present, offline allocation of VMs probably cannot be used in practice where processing of VM requests is performed as VM requests are received. Thus, the primal and dual problems presented above for the offline allocation of VMs may be used to develop a process for online allocation of VMs with a constant competitive ratio.

The CRMS 140 may support online allocation of VMs in response to VM requests. In at least some embodiments, online allocation of VMs in response to a VM request includes selecting VMs and datacenters for VMs in each time slot t. As previously described, when the VM request l is received and processing of VM request l is initiated for determining allocation of VMs in response to VM request l, the following information is available: (1) the group of VMs requested (denoted as m(l), where the VMs belonging to a particular VM request are indexed by j, (2) the number of VMs requested (denoted as N(l,j)) for VM group j for VM request l, (3) a set of time slots T(l) during which the requested VMs of VM request l are to be instantiated, (4) a set of allocation constraints to be satisfied by the group of VMs requested (e.g., constraints on the cloud locations i at which the requested VMs may be instantiated, indications of cloud locations i at which the requested VMs cannot be instantiated, or the like, as well as various combinations thereof), and (5) the remaining capacity available at each of the cloud locations i. Additionally, let Pₗ denote the set of mappings of VM to cloud locations i that are feasible. The CRMS 140 determines a resource mapping P∈Pₗ based on the VM request l and the remaining capacity available at each of the cloud locations i, where the resource mapping P∈Pₜ specifies allocation of the requested VMs of VM request l to cloud locations i of the system.

In at least some embodiments, determination of the resource mapping P∈Pₗ based on the VM request l is performed using a primal-dual scheme, such as the primal-dual scheme described above with respect to offline allocation of VMs. The dual variables π(l) and δ(i,t) defined above with respect to offline allocation of VMs are initialized to zero and are updated at the end of each time slot t. The following steps are performed for each VM request l:

(1) for each time slot t, the weight of assigning VM j to cloud location i at time t is computed as w(i,j,t)=N(l,j)[1−δ(i,t)];

(2) for each time slot t, the maximum weight mapping P∈Pₗ is computed, where the weight of a mapping P is computed as

$${\sum }_{j}^{ } w ( P 𝓁 , j , t ) , j , t ) ;$$

(3) for each VM j update the total load allocated to cloud location i for time slot t based on R(P(l,j,t),t)←R(P(l,j,t),t)+N(l,j)∀t∈T(l) (i.e., R(i,t) is used to keep running track of the total load allocated to cloud location i for time slot t); and

(4) after the VMs have been assigned to cloud locations i , the values of the dual variables π(l,t) and δ(i,t) for the VMs j of are updated for each time slot t∈T(l) as follows:

$$δ ( P ( 𝓁 , j , t ) , t ) ← δ ( P ( 𝓁 , j , t ) , t ) [ 1 + \frac{R ( P ( 𝓁 , j , t ) , t )}{B ( i , t )} ] + \frac{1}{c - 1} \frac{R ( P ( 𝓁 , j , t ) , t )}{B ( i , t )} , \\ π ( 𝓁 , t ) ← {\sum }_{i}^{ } A ( 𝓁 , P , i , t ) [ 1 - δ ( i , t ) ] .$$

It will be appreciated that the complexity of computing the maximum weight mapping P∈Pₗ depends on the type of allocation constraints specified. In the case of the cloud location restriction constraint, for each VM j the cloud location i∈S(l, j) may be selected such that the weight of assigning VM j to cloud location i at time t (namely, w(i,j,t)) is maximized. In other words,

$$P ( 𝓁 , j , t ) = arg \begin{matrix}max \\ i ∈ S ( 𝓁 , j )\end{matrix} w ( i , j , t ) .$$

It will be appreciated that the value of π(l,t) is computed at time slot l and is not updated later, and that the value of δ(i,t) is updated whenever a VM is allocated for time slot t for cloud location i .

It may be shown that a dual feasible solution is maintained after processing of each VM request where the value of δ(i,t) is used in performing the VM allocation for the VM request l, but the value of π(l,t) is only expected to be used in analysis of the process for performing VM allocations.

In at least some embodiments, a performance guarantee may be provided by comparing performance of online allocation of VMs to offline allocation of VMs. The offline VM allocation process has knowledge of the future and was formulated as an integer programming problem as discussed above such that, if the individual VM requests are small compared to the cloud location capacities, then processing of VM requests for allocating VMs is performed such that the online process for allocating VMs allocated more than a constant fraction of the VMs allocated by the offline process for allocating VMs.

It will be appreciated that, although primarily depicted and described herein with respect to embodiments of the cloud resource allocation capability in which the migrations of cloud resources are pre-planned migrations of cloud resources, in at least some embodiments the cloud resource allocation capability may be adapted to support reactive migrations of cloud resources. The reactive migration of cloud resources may be initiated in response to any suitable type(s) of trigger condition(s), such as a determination that physical resources on which the cloud resources are allocated are overloaded or have failed, a determination that a data center or a portion of a data center hosting the cloud resources is to be taken offline for maintenance, a determination that cloud defragmentation is to be performed for a data center or a portion of a data center hosting the cloud resources, or the like. In at least some embodiments, allocation of cloud resources within a distributed cloud system may include receiving a cloud resource allocation request including cloud resource request information that includes an indication of an amount of cloud resources requested, determining distributed cloud system status information including an indication of mappings of existing cloud resources of the distributed cloud system to physical resources of the distributed cloud system, determining a cloud resource migration plan indicative of migration of allocated cloud resources between physical resources of the distributed cloud system, and determining a resource allocation for the cloud resource allocation request based on the cloud resource request information, the distributed cloud system status information, and the cloud resource migration plan. In at least some embodiments, allocation of cloud resources within a distributed cloud system may include receiving a request for allocation of a first set of cloud resources within the cloud system, determining a cloud resource allocation for the first set of cloud resources based on the request for allocation of the first set of cloud resources where the cloud resource allocation specifies a mapping of the first set of cloud resources onto a first set of physical resources of the cloud system, determining a migration plan for migrating the first set of cloud resources within the cloud system from the first set of physical resources of the cloud system to a second set of physical resources of the cloud system, receiving a request for allocation of a second set of cloud resources within the cloud system, and determining a cloud resource allocation for the second set of cloud resources based on the request for allocation of the second set of cloud resources and the migration plan for migrating the first set of cloud resources within the cloud system.

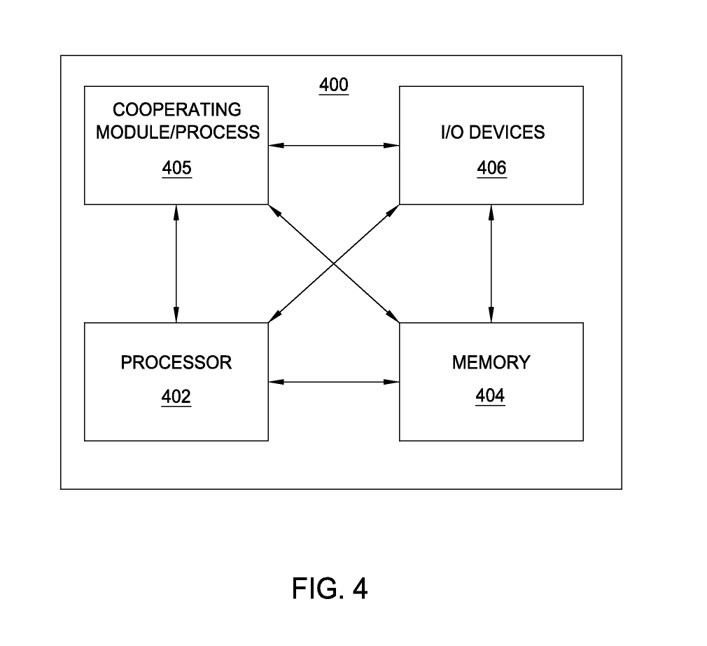

FIG. 4 depicts a high-level block diagram of a computer suitable for use in performing functions described herein.

The computer 400 includes a processor 402 (e.g., a central processing unit (CPU) and/or other suitable processor(s)) and a memory 404 (e.g., random access memory (RAM), read only memory (ROM), and the like).

The computer 400 also may include a cooperating module/process 405. The cooperating process 405 can be loaded into memory 404 and executed by the processor 402 to implement functions as discussed herein and, thus, cooperating process 405 (including associated data structures) can be stored on a computer readable storage medium, e.g., RAM memory, magnetic or optical drive or diskette, and the like.

The computer 400 also may include one or more input/output devices 406 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 400 depicted in FIG. 4 provides a general architecture and functionality suitable for implementing functional elements described herein and/or portions of functional elements described herein. For example, the computer 400 provides a general architecture and functionality suitable for implementing one or more of an element of a DDC 110, an element of CN 120, CD 130, CRMS 140, or the like.

It will be appreciated that the functions depicted and described herein may be implemented in software (e.g., via implementation of software on one or more processors, for executing on a general purpose computer (e.g., via execution by one or more processors) so as to implement a special purpose computer, and the like) and/or may be implemented in hardware (e.g., using a general purpose computer, one or more application specific integrated circuits (ASIC), and/or any other hardware equivalents).

It will be appreciated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

It will be appreciated that the term “or” as used herein refers to a non-exclusive “or,” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus for allocating cloud resources within a cloud system, the apparatus comprising:
a processor and a memory communicatively connected to the processor, the processor configured to:
receive a cloud resource request comprising cloud resource request information, the cloud resource request information comprising a cloud resource allocation parameter associated with allocation of requested cloud resources responsive to the cloud resource request and a cloud resource migration parameter associated with migration of cloud resources allocated responsive to the cloud resource request; and
determine, based on the cloud resource allocation parameter and the cloud resource migration parameter, a cloud resource allocation comprising cloud resource allocation information specifying allocation of cloud resources within the cloud system responsive to the cloud resource request and cloud resource migration information specifying migration of cloud resources allocated within the cloud system responsive to the cloud resource request.

2. The apparatus of claim 1, wherein the processor is configured to:
determine the cloud resource allocation information based on the cloud resource allocation parameter and the cloud resource migration parameter.

3. The apparatus of claim 1, wherein the processor is configured to:
determine the cloud resource migration information based on the cloud resource migration parameter and the cloud resource allocation parameter.

4. The apparatus of claim 1, wherein the cloud resource allocation parameter comprises at least one of a type of cloud resources requested, a quantity of cloud resources requested, a location for the cloud resources, or a latency constraint.

5. The apparatus of claim 1, wherein the cloud resource migration parameter comprises at least one of a time at which cloud resources are to be migrated, a location from which cloud resources are to be migrated, a location to which cloud resources are to be migrated, or a maximum number of times that cloud resources may be migrated.

6. The apparatus of claim 1, wherein the cloud resource allocation information specifies a mapping of cloud resources to physical resources of the cloud system.

7. The apparatus of claim 1, wherein the cloud resource migration information comprises at least one of a time at which cloud resources are to be migrated, a location from which cloud resources are to be migrated, or a location to which cloud resources are to be migrated.

8. The apparatus of claim 1, wherein the processor is configured to:
initiate, based on the cloud resource migration information of the cloud resource allocation, migration of allocated cloud resources allocated responsive to the cloud resource request.

9. The apparatus of claim 1, wherein the processor is configured to:
receive a next cloud resource request comprising cloud resource request information; and
determine, based on the cloud resource migration information of the cloud resource allocation, a next cloud resource allocation for the next cloud resource request.

10. The apparatus of claim 1, wherein the processor is configured to:
determine the cloud resource allocation based on cloud system status information associated with the cloud system;
update the cloud system status information to include the cloud resource allocation information;
receive a next cloud resource request comprising cloud resource request information; and
determine, based on the cloud resource migration information of the updated cloud resource information and the cloud resource request information of the next cloud resource request, a next cloud resource allocation for the next cloud resource request.

11. A method for allocating cloud resources within a cloud system, the method comprising:
using a processor and a memory for:
receiving a cloud resource request comprising cloud resource request information, the cloud resource request information comprising a cloud resource allocation parameter associated with allocation of requested cloud resources responsive to the cloud resource request and a cloud resource migration parameter associated with migration of cloud resources allocated responsive to the cloud resource request; and
determining, based on the cloud resource allocation parameter and the cloud resource migration parameter, a cloud resource allocation comprising cloud resource allocation information specifying allocation of cloud resources within the cloud system responsive to the cloud resource request and cloud resource migration information specifying migration of cloud resources allocated within the cloud system responsive to the cloud resource request.

12. The method of claim 11, wherein the cloud resource allocation information is determined based on the cloud resource allocation parameter and the cloud resource migration parameter.

13. The method of claim 11, wherein the cloud resource migration information is determined based on the cloud resource migration parameter and the cloud resource allocation parameter.

14. The method of claim 11, wherein the cloud resource allocation parameter comprises at least one of a type of cloud resources requested, a quantity of cloud resources requested, a location for the cloud resources, or a latency constraint.

15. The method of claim 11, wherein the cloud resource migration parameter comprises at least one of a time at which cloud resources are to be migrated, a location from which cloud resources are to be migrated, a location to which cloud resources are to be migrated, or a maximum number of times that cloud resources may be migrated.

16. The method of claim 11, wherein the cloud resource allocation information specifies a mapping of cloud resources to physical resources of the cloud system.

17. The method of claim 11, wherein the cloud resource migration information comprises at least one of a time at which cloud resources are to be migrated, a location from which cloud resources are to be migrated, or a location to which cloud resources are to be migrated.

18. The method of claim 11, further comprising:
initiating, based on the cloud resource migration information of the cloud resource allocation, migration of allocated cloud resources allocated responsive to the cloud resource request.

19. The method of claim 11, further comprising:
receiving a next cloud resource request comprising cloud resource request information; and
determining, based on the cloud resource migration information of the cloud resource allocation, a next cloud resource allocation for the next cloud resource request.

20. The method of claim 11, further comprising:
determining the cloud resource allocation based on cloud system status information associated with the cloud system;
updating the cloud system status information to include the cloud resource allocation information;
receiving a next cloud resource request comprising cloud resource request information; and
determining, based on the cloud resource migration information of the updated cloud resource information and the cloud resource request information of the next cloud resource request, a next cloud resource allocation for the next cloud resource request.

21. A computer-readable storage medium storing instructions which, when executed by a computer, cause the computer to perform a method for allocating cloud resources within a cloud system, the method comprising:
receiving a cloud resource request comprising cloud resource request information, the cloud resource request information comprising a cloud resource allocation parameter associated with allocation of requested cloud resources responsive to the cloud resource request and a cloud resource migration parameter associated with migration of cloud resources allocated responsive to the cloud resource request; and
determining, based on the cloud resource allocation parameter and the cloud resource migration parameter, a cloud resource allocation comprising cloud resource allocation information specifying allocation of cloud resources within the cloud system responsive to the cloud resource request and cloud resource migration information specifying migration of cloud resources allocated within the cloud system responsive to the cloud resource request.
